(19) United States
(12) Patent Application Publication
(10) Pub. No.: US 2021/0009444 A1
(43) Pub. Date: Jan. 14, 2021

(54) Use of Tertiary Treated Sewage Effluent Sterilized With Ionizing Radiation in Upstream Well Applications

(71) Applicant: Saudi Arabian Oil Company, Dhahran (SA)

(72) Inventors: Serguey Viktorov Arkadakskiy, Alberta (CA); Michael Cowie, Dhahran (SA)

(21) Appl. No.: 16/507,819

(22) Filed: Jul. 10, 2019

(51) Int. Cl. C02F 1/30; C02F 9/00

(52) U.S. Cl. CPC C02F 1/307; C02F 9/00; C02F 2209/11; C02F 2209/003; C02F 2209/001

(57) ABSTRACT

Methods, systems, and apparatuses for using irradiated tertiary treated sewage effluent (TTSE) for use in upstream and downstream well operations are disclosed. In some implementations, the TTSE is treated with ionizing radiation, such as gamma rays or electron beam radiation, in order to sterilize the TTSE. The sterilized TTSE is utilized in a well treatment operation, such as drilling operations, completion operations, pressure maintenance operations, and hydraulic fracturing operations. Sterilization of the TTSE prior to introduction into a well prevents damage to the well, such as fouling of a reservoir or reduction in permeability of the reservoir or both.

### TECHNICAL FIELD

The present disclosure relates to upstream well operations.

### BACKGROUND

Water resources for use in petroleum production operations can be scarce resources, especially in remote locations where some petroleum wells are located. Vast quantities of groundwater, including high-quality fresh groundwater, are used for upstream operations, including, drilling, performing completions, hydraulic fracturing, and maintaining reservoir pressures.

### SUMMARY

A first aspect of the present disclosure is directed to a method using tertiary treated sewage effluent (TTSE) in an upstream well treatment. The method may include applying ionizing radiation to TTSE and using the irradiated TTSE during the course of an upstream well operation. A second aspect of the present disclosure is directed to a computer-implemented method performed by one or more processors for performing an upstream well operation using tertiary treated sewage effluent (TTSE). The method may include the applying ionizing radiation to TTSE and using the irradiated TTSE during the course of an upstream well operation. A third aspect of the present disclosure is directed to an apparatus for performing an upstream well operation using tertiary treated sewage effluent (TTSE). The apparatus includes one or more processors and a non-transitory computer-readable storage medium coupled to the one or more processors and storing programming instructions for execution by the one or more processors. The programming instructions may be operable to instruct the one or more processors to apply ionizing radiation to TTSE and conduct an upstream well operation using the irradiated TTSE.

The various aspects may include one or more of the following features. Applying ionizing radiation to TTSE may include applying ionizing radiation to a flow of TTSE. Using the irradiated TTSE during the course of an upstream well operation may include using the irradiated TTSE in an upstream well operation that includes a drilling operation, a completion operation, a reservoir pressure maintenance operation, and a hydraulic fracturing operation. Using the irradiated TTSE during the course of an upstream well operation may include forming a hydraulic fracturing fluid using the irradiated TTSE and fracturing a formation using the hydraulic fracturing fluid. Using the irradiated TTSE during the course of an upstream well operation may include forming a drilling mud with the irradiated TTSE and pumping the drilling mud into a well during a drilling operation.

The various aspects may include one or more of the following features. The programming instructions to instruct the one or more processors to apply ionizing radiation to TTSE may include programming instructions to instruct the one or more processors to generate a flow of the TTSE and applying ionizing radiation to a flow of TTSE. The programming instructions to instruct the one or more processors to conduct an upstream well operation using the irradiated TTSE may include programming instructions to instruct the one or more processors to conduct, using the irradiated TTSE, an upstream well operation that includes a drilling operation, a completion operation, a reservoir pressure maintenance operation, and a hydraulic fracturing operation. The programming instructions to instruct the one or more processors to conduct an upstream well operation using the irradiated TTSE may include programming instructions to instruct the one or more processors to form a hydraulic fracturing fluid using the irradiated TTSE and fracture a formation using the hydraulic fracturing fluid. The programming instructions to instruct the one or more processors to conduct an upstream well operation using the irradiated TTSE may include programming instructions to instruct the one or more processors to form a drilling mud with the irradiated TTSE and pump the drilling mud into a well during a drilling operation.

The details of one or more embodiments of the present disclosure are set forth in the accompanying drawings and the description that follows. Other features, objects, and advantages of the present disclosure will be apparent from the description and drawings, and from the claims.

### DESCRIPTION OF DRAWINGS

FIG. 1 is an example system for treating tertiary treated sewage effluent (TTSE) with ionizing radiation, according to some implementations of the present disclosure.

FIG. 2 is a flowchart of an example method for utilizing TTSE, sterilized with ionizing radiation, in upstream well operations, according to some implementations of the present disclosure.

FIG. 3 is a block diagram illustrating an example computer system used to provide computational functionalities associated with described algorithms, methods, functions, processes, flows, and procedures as described in the present disclosure, according to some implementations of the present disclosure.

### DETAILED DESCRIPTION

For the purposes of promoting an understanding of the principles of the present disclosure, reference will now be made to the implementations illustrated in the drawings, and specific language will be used to describe the same. Nevertheless, no limitation of the scope of the disclosure is intended. Any alterations and further modifications to the described devices, systems, methods, and any further application of the principles of the present disclosure are fully contemplated as would normally occur to one skilled in the art to which the disclosure relates. In particular, it is fully contemplated that the features, components, steps, or a combination of these described with respect to one implementation may be combined with the features, components, steps, or a combination of these described with respect to other implementations of the present disclosure.

An abundant source of water (that is, wastewater) is used to replace, in whole or in part, natural groundwater resources in upstream well operations. As a result, consumption of groundwater resources is reduced, and, consequently, pressure placed on natural groundwater resources is reduced. Tertiary treated sewage effluent (TTSE), a form of wastewater, is an abundant economic alternative to groundwater and has low salinity and low sulfur levels. In some cases, a low percentage of TTSE is reused. For example, in some case, approximately 20% of TTSE is reused, with the remainder of the TTSE being discarded.

The inability of conventional technologies, such as chlorination and UV irradiation, to remove microorganisms completely from TTSE renders the use of TTSE for upstream applications undesirable. This is because, without eradication of microbial contamination from the TTSE, introducing TTSE into a reservoir in the course of a treatment operation could cause reservoir fouling, loss of permeability, or both. However, treatment of the TTSE with ionizing radiation, such as gamma rays or electron beam radiation, is an effective method for complete wastewater sterilization.

In contrast to conventional treatment methods, the effectiveness of ionizing radiation is largely independent of the wastewater's physical parameters such as total suspended solids (TSS) and turbidity, which often interfere with other types of treatments, including UV irradiation treatment. Treating wastewater with ionizing radiation, in combination with other conventional treatments (such as primary treatment and secondary treatment), results in decomposition of many refractory organic compounds.

As a result of ionizing radiation sterilization, sterilized TTSE is a water resource that is usable to replace, in whole or in part, other water resources, such as groundwater, in conducting well operations, particularly upstream well operations. These upstream well operations include, but are not limited to, drilling operations (such as gel and mud production), completion operations, pressure maintenance operations, and hydraulic fracturing operations. In still other implementations, TTSE sterilized using ionizing radiation may also be used in downstream refining operations (such as salt washing); carbon dioxide (CO₂) dissolution; transportation operations (such as for use as a medium in carbon capture and storage operations); and groundwater aquifer recharge, including the prevention of aquifer salinization caused by groundwater over-abstraction.

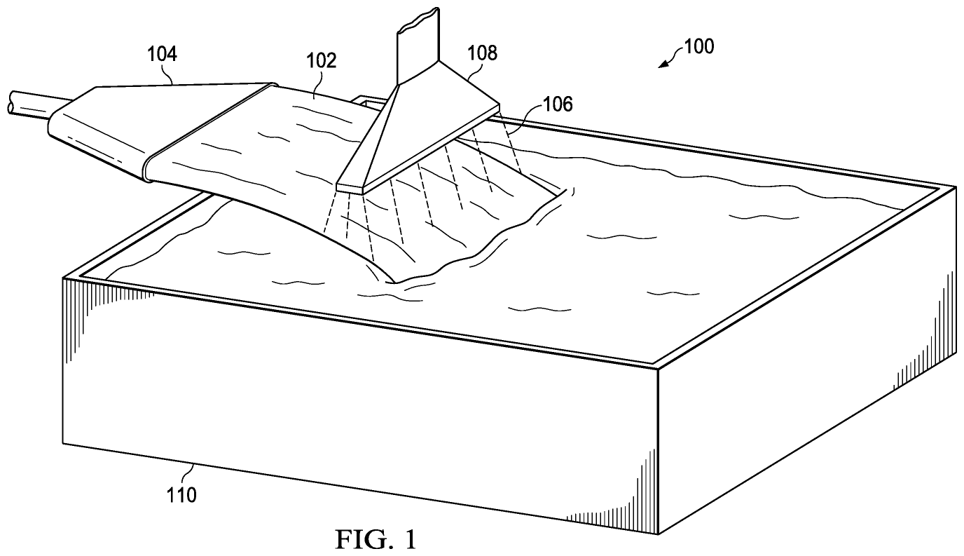

FIG. 1 is an example ionizing radiation sterilizing system 100 in which a TTSE flow 102 is ejected from a nozzle 104 into a path of a beam 106 of ionizing radiation emitted from a nozzle 108. As the flow 102 of TTSE passes through the beam 106 of ionizing radiation, the TTSE is sterilized. The TTSE is collected in a container, such as a tank 110.

In some implementations, an ionizing radiation dosage within a range of approximately one to three kilogray (kGy) may be applied to the flow 102 of TTSE. As a result of exposure to the ionizing radiation, such as within the indicated range, bacteria within the TTSE can be reduced by 98%, 99%, and up to 99.9%. At these levels of bacteria removal, the TTSE treated with ionizing radiation can be used in upstream well operations without the risk of reservoir fouling, a reduction in permeability of the reservoir, or both.

The scope of the disclosure is not limited to the example dosage range indicated earlier. Rather, the dosage of ionizing radiation may be varied. A dosage of ionizing radiation may be increased, for example, up to 20 to 30 kGy in some implementations, or, in other implementations, a dosage may be reduced to a level below one kGy. Further, a dosage of ionizing radiation may vary depending on other characteristics of the TTSE. For example, the dosage may vary depending on biological loading of the TTSE. In some implementations, for TTSE having increased biological loading levels, an increased dosage of ionizing radiation may be used. In other implementations, for TTSE having a reduced level of biological loading, a reduced dosage of ionizing radiation may be used.

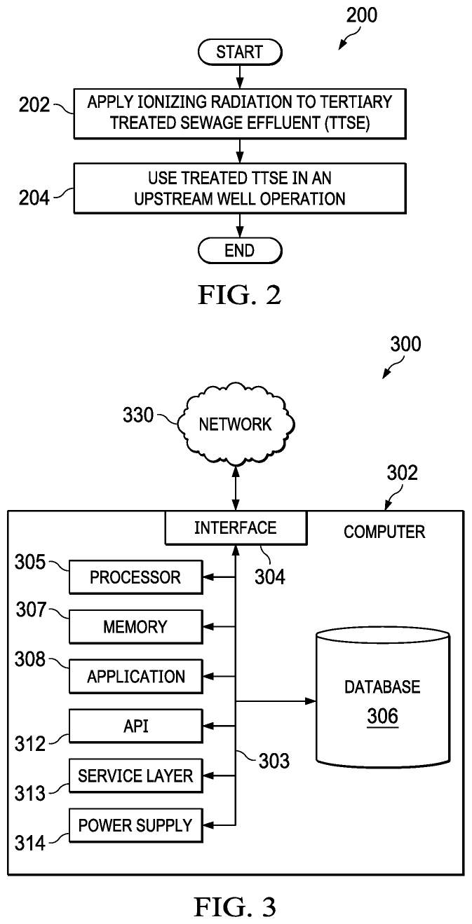

FIG. 2 is a flowchart of an example method 200 for the use of treated TTSE for upstream well operations. At 202, ionizing radiation is applied to TTSE. Examples of the ionizing radiation include gamma rays or electron beam radiation. In some implementations, the ionizing radiation may be applied to a flow of TTSE. In some implementations, the flow of TTSE may be collected in a container after application of the ionizing radiation. At 204, the treated TTSE is used in an upstream well operation. Example upstream well operations include drilling operations (such as gel and mud production), completion operations, pressure maintenance operations, and hydraulic fracturing operations. A fractional component of treated TTSE that may be used in an upstream operation may be from zero, where water used for an upstream operation does not include any treated TTSE, to one, where all of the water used for an upstream operation is treated TTSE and no other water type is used. The fractional component of treated TTSE may vary depending on one or more considerations. For example, a cost associated with obtaining the treated TTSE or other water sources, the availability of treated TTSE or other water sources, and the compatibility of TTSE with minerals within a reservoir or another water type are example consideration that are taken into consideration when determining whether treated TTSE is used and, if so, what fractional component of the treated TTSE is used. For example, in some instances, whether treated TTSE is used and, if so, the fractional component of the treated TTSE to be used may be determined, in whole or in part, based on whether the treated TTSE poses a risk of unfavorable fluid-mineral reactions within a reservoir or a risk of unfavorable fluid-fluid mixing reactions, or both.

FIG. 3 is a block diagram of an example computer system 300 used to provide computational functionalities associated with described algorithms, methods, functions, processes, flows, and procedures described in the present disclosure, according to some implementations of the present disclosure. The illustrated computer 302 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 302 can include input devices such as keypads, keyboards, and touch screens that can accept user information. Also, the computer 302 can include output devices that can convey information associated with the operation of the computer 302. The information can include digital data, visual data, audio information, or a combination of information. The information can be presented in a graphical user interface (UI) (or GUI).

The computer 302 can serve in a role as a client, a network component, a server, a database, a persistency, or components of a computer system for performing the subject matter described in the present disclosure. The illustrated computer 302 is communicably coupled with a network 330. In some implementations, one or more components of the computer 302 can be configured to operate within different environments, including cloud-computing-based environments, local environments, global environments, and combinations of environments.

At a high level, the computer 302 is an electronic computing device operable to receive, transmit, process, store, and manage data and information associated with the described subject matter. According to some implementations, the computer 302 can also include, or be communicably coupled with, an application server, an email server, a web server, a caching server, a streaming data server, or a combination of servers.

The computer 302 can receive requests over network 330 from a client application (for example, executing on another computer 302). The computer 302 can respond to the received requests by processing the received requests using software applications. Requests can also be sent to the computer 302 from internal users (for example, from a command console), external (or third) parties, automated applications, entities, individuals, systems, and computers.

Each of the components of the computer 302 can communicate using a system bus 303. In some implementations, any or all of the components of the computer 302, including hardware or software components, can interface with each other or the interface 304 (or a combination of both), over the system bus 303. Interfaces can use an application programming interface (API) 312, a service layer 313, or a combination of the API 312 and service layer 313. The API 312 can include specifications for routines, data structures, and object classes. The API 312 can be either computer-language independent or dependent. The API 312 can refer to a complete interface, a single function, or a set of APIs.

The service layer 313 can provide software services to the computer 302 and other components (whether illustrated or not) that are communicably coupled to the computer 302. The functionality of the computer 302 can be accessible for all service consumers using this service layer. Software services, such as those provided by the service layer 313, can provide reusable, defined functionalities through a defined interface. For example, the interface can be software written in JAVA, C++, or a language providing data in extensible markup language (XML) format. While illustrated as an integrated component of the computer 302, in alternative implementations, the API 312 or the service layer 313 can be stand-alone components in relation to other components of the computer 302 and other components communicably coupled to the computer 302. Moreover, any or all parts of the API 312 or the service layer 313 can be implemented as child or sub-modules of another software module, enterprise application, or hardware module without departing from the scope of the present disclosure.

The computer 302 includes an interface 304. Although illustrated as a single interface 304 in FIG. 3, two or more interfaces 304 can be used according to particular needs, desires, or particular implementations of the computer 302 and the described functionality. The interface 304 can be used by the computer 302 for communicating with other systems that are connected to the network 330 (whether illustrated or not) in a distributed environment. Generally, the interface 304 can include, or be implemented using, logic encoded in software or hardware (or a combination of software and hardware) operable to communicate with the network 330. More specifically, the interface 304 can include software supporting one or more communication protocols associated with communications. As such, the network 330 or the interface's hardware can be operable to communicate physical signals within and outside of the illustrated computer 302.

The computer 302 includes a processor 305. Although illustrated as a single processor 305 in FIG. 3, two or more processors 305 can be used according to particular needs, desires, or particular implementations of the computer 302 and the described functionality. Generally, the processor 305 can execute instructions and can manipulate data to perform the operations of the computer 302, including operations using algorithms, methods, functions, processes, flows, and procedures as described in the present disclosure.

The computer 302 also includes a database 306 that can hold data for the computer 302 and other components connected to the network 330 (whether illustrated or not). For example, database 306 can be an in-memory, conventional, or a database storing data consistent with the present disclosure. In some implementations, database 306 can be a combination of two or more different database types (for example, hybrid in-memory and conventional databases) according to particular needs, desires, or particular implementations of the computer 302 and the described functionality. Although illustrated as a single database 306 in FIG. 3, two or more databases (of the same, different, or combination of types) can be used according to particular needs, desires, or particular implementations of the computer 302 and the described functionality. While database 306 is illustrated as an internal component of the computer 302, in alternative implementations, database 306 can be external to the computer 302.

The computer 302 also includes a memory 307 that can hold data for the computer 302 or a combination of components connected to the network 330 (whether illustrated or not). Memory 307 can store any data consistent with the present disclosure. In some implementations, memory 307 can be a combination of two or more different types of memory (for example, a combination of semiconductor and magnetic storage) according to particular needs, desires, or particular implementations of the computer 302 and the described functionality. Although illustrated as a single memory 307 in FIG. 3, two or more memories 307 (of the same, different, or combination of types) can be used according to particular needs, desires, or particular implementations of the computer 302 and the described functionality. While memory 307 is illustrated as an internal component of the computer 302, in alternative implementations, memory 307 can be external to the computer 302.

The application 308 can be an algorithmic software engine providing functionality according to particular needs, desires, or particular implementations of the computer 302 and the described functionality. For example, application 308 can serve as one or more components, modules, or applications. Further, although illustrated as a single application 308, the application 308 can be implemented as multiple applications 308 on the computer 302. In addition, although illustrated as internal to the computer 302, in alternative implementations, the application 308 can be external to the computer 302.

The computer 302 can also include a power supply 314. The power supply 314 can include a rechargeable or non-rechargeable battery that can be configured to be either user- or non-user-replaceable. In some implementations, the power supply 314 can include power-conversion and management circuits, including recharging, standby, and power management functionalities. In some implementations, the power-supply 314 can include a power plug to allow the computer 302 to be plugged into a wall socket or a power source to, for example, power the computer 302 or recharge a rechargeable battery.

There can be any number of computers 302 associated with, or external to, a computer system containing computer 302, with each computer 302 communicating over network 330. Further, the terms “client,” “user,” and other appropriate terminology can be used interchangeably, as appropriate, without departing from the scope of the present disclosure. Moreover, the present disclosure contemplates that many users can use one computer 302 and one user can use multiple computers 302.

Described implementations of the subject matter can include one or more features, alone or in combination.

For example, in a first implementation, a computer-implemented method performed by one or more processors for performing an upstream well operation using tertiary treated sewage effluent (TTSE) includes: applying ionizing radiation to TTSE; and using the irradiated TTSE during the course of an upstream well operation.

The foregoing and other described implementations can each, optionally, include one or more of the following features:

A first feature, combinable with any of the following features, wherein applying ionizing radiation to the TTSE includes applying ionizing radiation to a flow of TTSE.

A second feature, combinable with any of the previous or following features, wherein using the irradiated TTSE during the course of an upstream well operation includes using the irradiated TTSE in an upstream well operation that includes a drilling operation, a completion operation, a reservoir pressure maintenance operation, and a hydraulic fracturing operation.

A third feature, combinable with any of the previous or following features, wherein using the irradiated TTSE during the course of an upstream well operation includes: forming a hydraulic fracturing fluid using the irradiated TTSE; and fracturing a formation using the hydraulic fracturing fluid.

A fourth feature, combinable with any of the previous or following features, wherein using the irradiated TTSE during the course of an upstream well operation includes: forming a drilling mud with the irradiated TTSE; and pumping the drilling mud into a well during a drilling operation.

A fifth feature, combinable with any of the previous or following features, wherein the ionizing radiation is selected from the group consisting of gamma rays or electron beam radiation.

In a second implementation, a non-transitory, computer-readable medium stores one or more instructions executable by a computer system to perform operations including: applying ionizing radiation to TTSE; and using the irradiated TTSE during the course of an upstream well operation.

The foregoing and other described implementations can each, optionally, include one or more of the following features:

A first feature, combinable with any of the following features, wherein applying ionizing radiation to the TTSE includes applying ionizing radiation to a flow of TTSE.

A second feature, combinable with any of the previous or following features, wherein using the irradiated TTSE during the course of an upstream well operation includes using the irradiated TTSE in an upstream well operation that includes a drilling operation, a completion operation, a reservoir pressure maintenance operation, and a hydraulic fracturing operation.

A third feature, combinable with any of the previous or following features, wherein using the irradiated TTSE during the course of an upstream well operation includes: forming a hydraulic fracturing fluid using the irradiated TTSE; and fracturing a formation using the hydraulic fracturing fluid.

A fourth feature, combinable with any of the previous or following features, wherein using the irradiated TTSE during the course of an upstream well operation includes: forming a drilling mud with the irradiated TTSE; and pumping the drilling mud into a well during a drilling operation.

A fifth feature, combinable with any of the previous or following features, wherein applying ionizing radiation to TTSE comprises applying gamma rays or electron beam radiation to the TTSE

In a third implementation, a computer-implemented system includes one or more processors and a non-transitory computer-readable storage medium coupled to the one or more processors and storing programming instructions for execution by the one or more processors, the programming instructions instructing the one or more processors to: apply ionizing radiation to TTSE; and conduct an upstream well operation using the irradiated TTSE.

The foregoing and other described implementations can each, optionally, include one or more of the following features:

A first feature, combinable with any of the following features, wherein the programming instructions to instruct the one or more processors to apply ionizing radiation to TTSE include programming instructions to instruct the one or more processors to: generate a flow of the TTSE and apply ionizing radiation to a flow of TTSE.

A second feature, combinable with any of the previous or following features, wherein the programming instructions to instruct the one or more processors to conduct an upstream well operation using the irradiated TTSE include programming instructions to instruct the one or more processors to: conduct, using the irradiated TTSE, an upstream well operation of the group consisting of a drilling operation, a completion operation, a reservoir pressure maintenance operation, and a hydraulic fracturing operation.

A third feature, combinable with any of the previous or following features, wherein the programming instructions to instruct the one or more processors to conduct an upstream well operation using the irradiated TTSE include programming instructions to instruct the one or more processors to: form a hydraulic fracturing fluid using the irradiated TTSE and fracture a formation using the hydraulic fracturing fluid.

A fourth feature, combinable with any of the previous or following features, wherein the programming instructions to instruct the one or more processors to conduct an upstream well operation using the irradiated TTSE include programming instructions to instruct the one or more processors to: form a drilling mud with the irradiated TTSE and pump the drilling mud into a well during a drilling operation.

A fifth feature, combinable with any of the previous or following features, wherein the ionizing radiation comprises gamma rays or electron beam radiation.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as standalone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/nonvolatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system includes a computer memory interoperably coupled with a hardware processor configured to perform the computer-implemented method or the instructions stored on the non-transitory, computer-readable medium.

A number of embodiments of the present disclosure have been described. Nevertheless, it will be understood that various modifications may be made without departing from the spirit and scope of the present disclosure. Accordingly, other embodiments are within the scope of the following claims.

What is claimed is:

1. A method of using tertiary treated sewage effluent (TTSE) in an upstream well treatment, the method comprising:
applying ionizing radiation to TTSE; and
using the irradiated TTSE during the course of an upstream well operation.

2. The method of claim 1, wherein applying ionizing radiation to the TTSE comprises applying ionizing radiation to a flow of TTSE.

3. The method of claim 1, wherein using the irradiated TTSE during the course of an upstream well operation comprises using the irradiated TTSE in an upstream well operation of the group consisting of a drilling operation, a completion operation, a reservoir pressure maintenance operation, and a hydraulic fracturing operation.

4. The method of claim 1, wherein using the irradiated TTSE during the course of an upstream well operation comprises:
forming a hydraulic fracturing fluid using the irradiated TTSE; and
fracturing a formation using the hydraulic fracturing fluid.

5. The method of claim 1, wherein using the irradiated TTSE during the course of an upstream well operation comprises:
forming a drilling mud with the irradiated TTSE; and
pumping the drilling mud into a well during a drilling operation.

6. The method of claim 1, wherein the ionizing radiation is selected from the group consisting of gamma rays or electron beam radiation.

7. A computer-implemented method performed by one or more processors for performing an upstream well operation using tertiary treated sewage effluent (TTSE), the method comprising the following operations:
applying ionizing radiation to TTSE; and
using the irradiated TTSE during the course of an upstream well operation.

8. The computer-implemented method of claim 7, wherein applying ionizing radiation to TTSE comprises applying ionizing radiation to a flow of TTSE.

9. The computer-implemented method of claim 7, wherein using the irradiated TTSE during the course of an upstream well operation comprises using the irradiated TTSE in an upstream well operation of the group consisting of a drilling operation, a completion operation, a reservoir pressure maintenance operation, and a hydraulic fracturing operation.

10. The computer-implemented method of claim 7, wherein using the irradiated TTSE during the course of an upstream well operation comprises:
forming a hydraulic fracturing fluid using the irradiated TTSE; and
fracturing a formation using the hydraulic fracturing fluid.

11. The computer-implemented method of claim 7, wherein using the irradiated TTSE during the course of an upstream well operation comprises:
forming a drilling mud with the irradiated TTSE; and
pumping the drilling mud into a well during a drilling operation.

12. The computer-implemented method of claim 7, wherein applying ionizing radiation to TTSE comprises applying gamma rays or electron beam radiation to the TTSE.

13. An apparatus for performing an upstream well operation using tertiary treated sewage effluent (TTSE), the apparatus comprising:
one or more processors; and
a non-transitory computer-readable storage medium coupled to the one or more processors and storing programming instructions for execution by the one or more processors, the programming instructions instruct the one or more processors to:
apply ionizing radiation to TTSE; and
conduct an upstream well operation using the irradiated TTSE.

14. The apparatus of claim 13, wherein the programming instructions to instruct the one or more processors to apply ionizing radiation to TTSE comprise programming instructions to instruct the one or more processors to:
generate a flow of the TTSE; and
apply ionizing radiation to a flow of TTSE.

15. The apparatus of claim 13, wherein the programming instructions to instruct the one or more processors to conduct an upstream well operation using the irradiated TTSE comprise programming instructions to instruct the one or more processors to conduct, using the irradiated TTSE, an upstream well operation of the group consisting of a drilling operation, a completion operation, a reservoir pressure maintenance operation, and a hydraulic fracturing operation.

16. The apparatus of claim 13, wherein the programming instructions to instruct the one or more processors to conduct an upstream well operation using the irradiated TTSE comprise programming instructions to instruct the one or more processors to:
form a hydraulic fracturing fluid using the irradiated TTSE; and
fracture a formation using the hydraulic fracturing fluid.

17. The apparatus of claim 13, wherein the programming instructions to instruct the one or more processors to conduct an upstream well operation using the irradiated TTSE comprise programming instructions to instruct the one or more processors to:
form a drilling mud with the irradiated TTSE; and
pump the drilling mud into a well during a drilling operation.

18. The apparatus of claim 13, wherein the ionizing radiation comprises gamma rays or electron beam radiation.
